(19) United States
(12) Patent Application Publication
(10) Pub. No.: US 2026/0093677 A1
(43) Pub. Date: Apr. 2, 2026

(54) NATIVE OBJECT VERSIONING

(71) Applicant: Teradata US, Inc., San Diego, CA (US)

(72) Inventor: Denis Molin, Draveil (FR)

(73) Assignee: Teradata US, Inc., San Diego, CA (US)

(21) Appl. No.: 18/902,802

(22) Filed: Sep. 30, 2024

(51) Int. Cl. G06F 16/21

(52) U.S. Cl. CPC G06F 16/219

(57) ABSTRACT

A system may include a storage device and at least one processor in communication with the storage device. The at least one processor may receive a query that comprises a reference to at least one data object. The at least one processor may identify a locally-stored version of the at least one data object. The at least one processor may retrieve a current version of the at least one data object. The at least one processor may compare the locally-stored version and the current version of the at least one data object. The at least one processor may, in response to the locally-stored version being different than the current version, update the locally-stored version to the current version. The at least one processor may execute the query based on the current version of the at least one data object. A method and computer-readable medium are also disclosed.

### BACKGROUND

Currently, tables and views in analytic systems, such as relational databases management systems are not versioned. Without versioning, there is difficulty in tracking changes in data objects, such as tables and views, as implemented by applications or other tools outside of the database management systems. Changes within these objects may cause difficulty when the objects are used in complex workflows. As the objects are used and reused, there is no identification of changes made to the object, and thus inconsistent results may occur.

Lack of versioning increases the difficulty to know if an object, such as a table or a view, includes changes. If it is feasible to track the changes in a single object, it becomes very difficult when dealing with a complex workflow involving several tables and views, often governed by different people or applications, and interconnected with different workflows. Therefore, this leads to a lack of consistency, hence a drop in data quality, when considering the history of the outputs of such a workflow. This is particularly true when dealing with advanced analytics when changes, modifications, and fine-tuning of the workflow are frequent.

Thus, it would be desirable to version tables and views to simplify versioning of worklflow pipeline management.

### SUMMARY

According to one aspect of the disclosure, a system may include a storage device. The system may further include at least one processor in communication with the storage device. The at least one processor may receive a query that comprises a reference to at least one data object. The at least one processor may identify a locally-stored version of the at least one data object. The at least one processor may retrieve a current version of the at least one data object. The at least one processor may compare the locally-stored version and the current version of the at least one data object. The at least one processor may, in response to the locally-stored version being different than the current version, update the locally-stored version to the current version. The at least one processor may execute the query based on the current version of the at least one data object.

According to another aspect of the disclosure, a method may include receiving, with a processor, a query that comprises a reference to at least one data object. The method may further include identifying, with the processor, a locally-stored version of the at least one data object. The method may further include retrieving, with the processor, a current version of the at least one data object. The method may further include comparing, with the processor, the locally-stored version and the current version of the at least one data object. The method may further include, in response to the locally-stored version being different than the current version, updating, with the processor, the locally-stored version to the current version. The method may further include executing, with the processor, the query based on the current version of the at least one data object.

According to another aspect of the disclosure, a computer-readable medium may be encoded with a plurality of instructions executable by a processor. The plurality of instructions may include instructions to receive a query that comprises a reference to at least one data object. The plurality of instructions may further include instructions to identify a locally-stored version of the at least one data object. The plurality of instructions may further include instructions to retrieve a current version of the at least one data object. The plurality of instructions may further include instructions to compare the locally-stored version and the current version of the at least one data object. The plurality of instructions may further include, in response to the locally-stored version being different than the current version, instructions to update the locally-stored version to the current version. The plurality of instructions may further include instructions to execute the query based on the current version of the at least one data object.

### BRIEF DESCRIPTION OF THE DRAWINGS

The disclosure may be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is a block diagram of example data object versioning.

FIG. 2 is a detailed block diagram of a process of determining ancestor versions of a view.

FIG. 3 is a block diagram of example version management.

FIG. 4 is an operational flow diagram of example data object versioning.

FIG. 5 is a block diagram of an example workflow.

FIG. 6 is a block diagram of another example workflow.

FIG. 7 is an operational flow diagram of example data object versioning.

FIG. 8 is a block diagram of an analytic system.

FIG. 9 is a block diagram of an example processing node.

FIG. 10 is a block diagram of an example optimizer module.

FIG. 11 is a block diagram of an example parser module.

FIG. 12 is a block diagram of example data object version comparison.

### DETAILED DESCRIPTION OF THE FIGURES

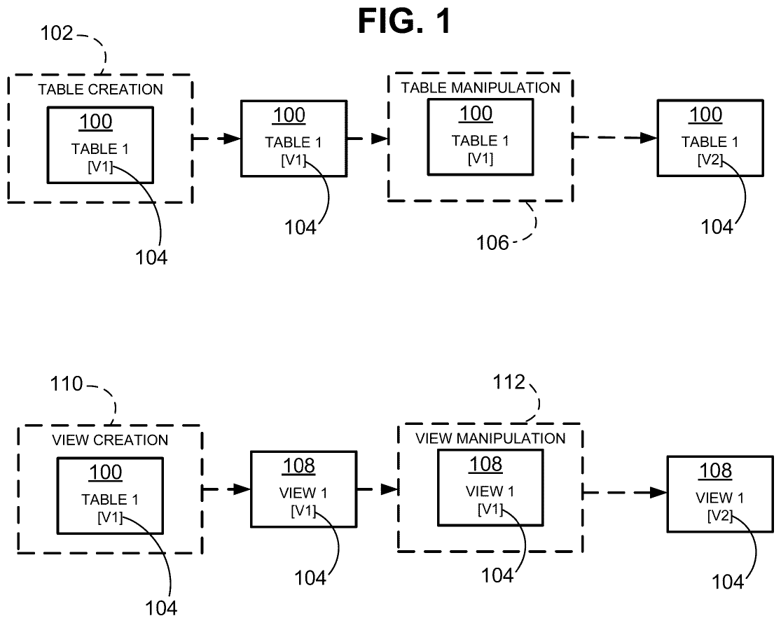

FIG. 1 is diagrammatic example of data object versioning. In one example, at table 100 (“Table 1”) may be created through table creation 102. The table 100 may also include a version identifier 104 denoted as “V1” in this example. After the table is created, the table 100 may undergo some manipulation 106, which can occur when any contents of the table are changed, such as the addition, removal, or revision of content, for example. If a table 100 is manipulated, the table 100 may be overwritten and given a new version identifier 104 denoted as “V2” in this example.

Similarly, table 100/version V1, may be used to create a view 108 through view creation 110. Each created view may include a version identifier 104, which is denoted as V1 for the created view 108. However, views are subject to change during their use due to various factors. In order to identify that a view has been manipulated in some fashion, such as the view definition being altered or the logic of the computations it implements could be updated, each view 108 may be given a different version identifier 104 once manipulated. In the example of FIG. 1, the view 104 may undergo some view manipulation 112. To denote the view 108 has been manipulated, a new version identifier 104 (“V2”) is given to the view 108 with the previous version being overwritten..

As views become more complex, for example, having multiple levels of ancestors, versioning of tables and views becomes more important to recognize if a view has changed. Often times, applications or other tools used in analytic environments maintain local copies of table and view names without regard for the version. This disclosure provides the manner in which various applications/tools are provided the certainty that a workflow has or has not been altered through a change to views and/or tables.

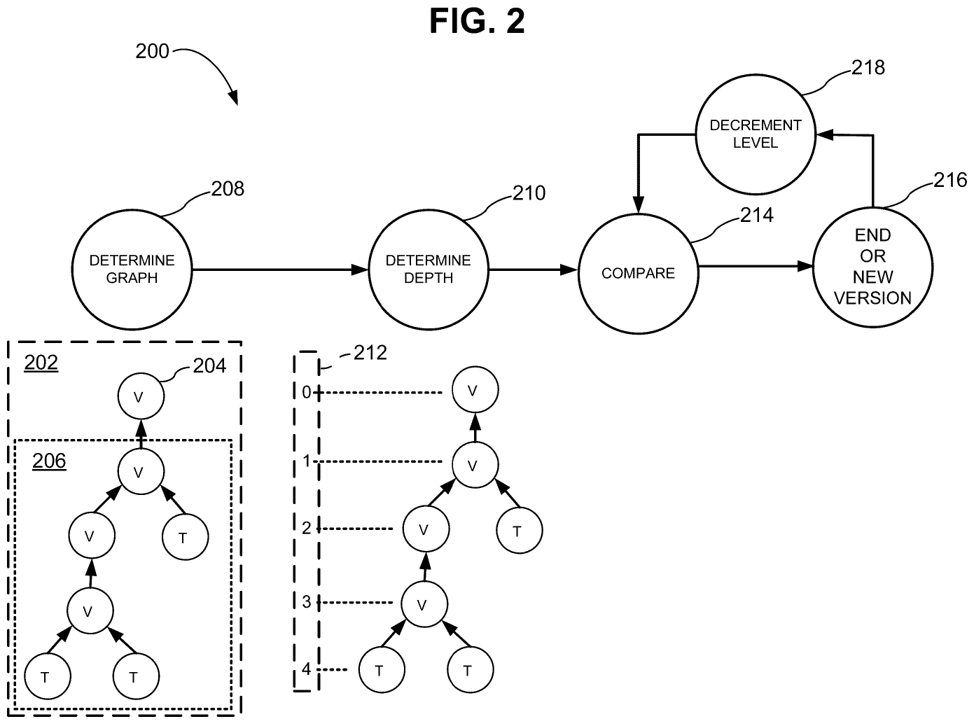

FIG. 2 is an example of a process 200 used to identify if a data object (e.g., a view) is a current version in a multi-ancestor setting. In one example, graph 202 may represent how data objects may be used to ultimately create a view. In the example of FIG. 2, view 204 is made up of ancestors 206, which include other views “V” and tables “T”. In the process 200, a graph determination stage 208 may be included. In the graph determination stage 208, the view and associated ancestors are identified. Once the graph 202 has been determined, the process 200 may include a depth determination stage 210. In the depth determination stage 210, the depth of the graph 202 may be determined to identify the identifier of ancestor levels 212. In the example of graph 202, the view 204 may represent level “0” with each additional level of ancestor increasing the level by one giving the graph 202 a depth level of four.

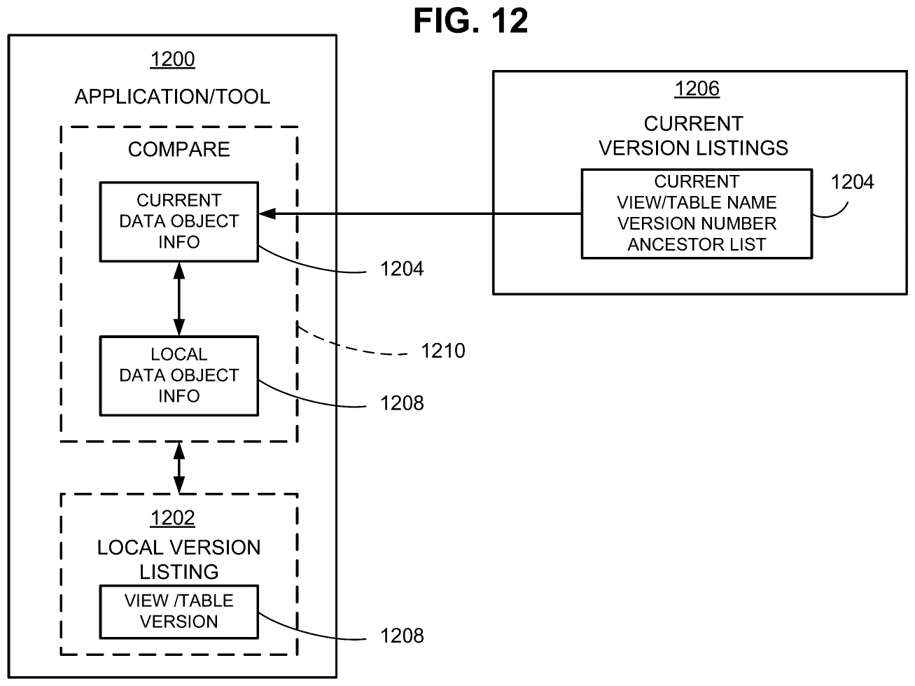

Once the depth of the graph 202 is determined, the process 200 may include a comparison stage 214. The comparison stage 214 may include initially comparing the version of the next-to-lowest level of the graph 202 (level “3” in FIG. 2) with a maintained listing of current versions (see FIG. 12). In this case, the versions of the view at level 3 would be compared with one another due to the lowest level having no ancestors. Once the comparison is made, the process may include a change stage 216 at which the local listing may be revised to indicate a new version of an ancestor. If additional levels exist, the process 200 includes a decrement level stage in which the next highest level has its ancestors compared at the comparison stage 210. Once the level reaches zero, the final revision to the version of the view 204 may be made and the update is complete.

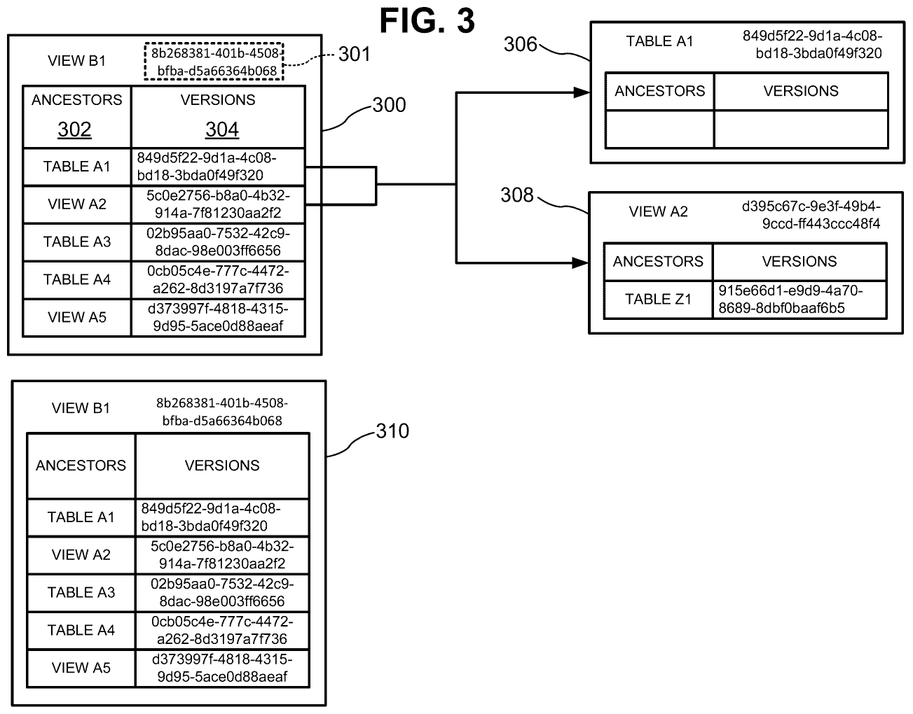

FIG. 3 is an example of a manner in which versions are managed illustrated through a view B1. Local version information 300 is an example of the last known version of a data object at an application or tool that has used the data object, which includes version identifier 301. In the instance of a table, there would only be a version identifier. However, in the example of a view, such as view B1, the local version information 300 may contain a list that includes ancestor names 302 and locally-known ancestor versions 304 maintained locally by a tool, application, or by a database itself, (see FIG. 12) which is the last known version of a view (as tables will not have ancestors, only versions of the table itself). Current version identifiers of a data object may be maintained separately such as a centrally-located repository (see FIG. 12) or in a distributed fashion based on implementation. When a data object is referenced in a task to be performed by the application or tool, a comparison may be made between list 300 and each ancestor 302 such as through the process 200 of FIG. 2. In FIG. 3, the example is shown when the version identifiers 304 of level one ancestors Table A1 and View A2 are being compared between those in the information 300 and the current version information 306 and 308 of the Table A1 and View A2, respectively, maintained separately. In the example of FIG. 3, the comparisons indicate that the versions of View A2 are different from one another. If these are the only differences, then the current version of View A2 may be reflected through creation of revised local version information 310. Each list as described may represent a tree structure, with the data object being referenced serving as a root node. Thus, the process 200 may begin at the leaf-node level of the tree propagating upward ultimately to the leaf being represented by the called data object. Moreover, each version identifier may be automatically generated without user intervention ensuring the integrity of the version identifying.

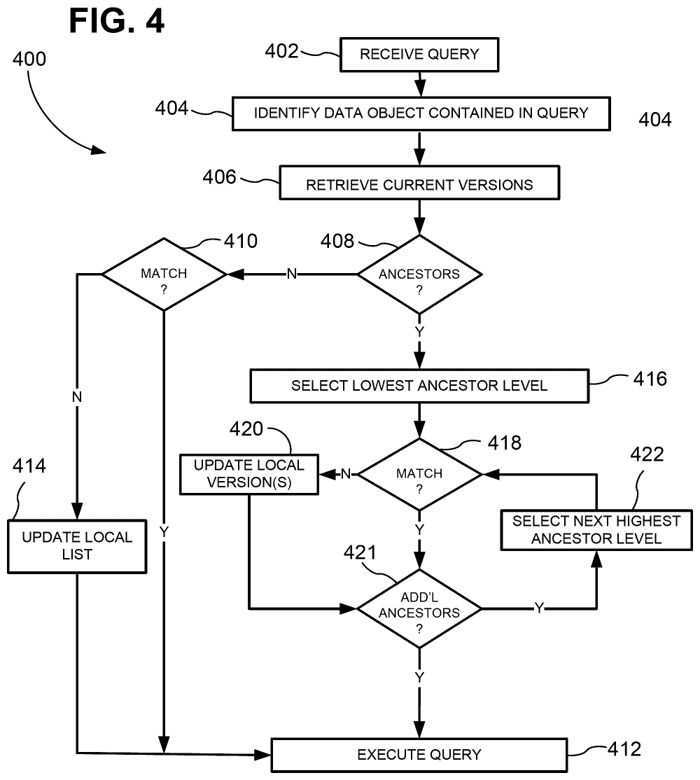

FIG. 4 is an operational flow diagram 400 of an example of data object versioning. In one example, a query may be received (402) by an application or tool. A data object may be identified in the query (404). A current version identifier of the data object may be retrieved (406) from a repository holding a list of names and current versions identifiers of data objects, as well as associated ancestor lists for views such as that shown in FIG. 12. The local version information (e.g., local version information 300) of the data object may be checked for ancestors (408). If no ancestors exist, such as in the example where the data object is a table, the version identifiers of the local version of the data object may be compared to the retrieved current version (410). If the version identifiers match, the query may be executed (412) or other additional tasks may be performed prior to execution if necessary. If the version identifiers do not match, the local version identifier may be updated to the current version identifier (414) and the query may be executed (412).

If ancestors do exist (408), such as in the case of a view, the next-to-lowest level of ancestors may be selected (416). The local version identifier (e.g., locally-known ancestor versions 304 in version list 300) of each ancestor at the selected level may be compared to the retrieved version identifier (418). If the version identifiers do not match, the local version 300 is updated with the any version identifiers that did not match the retrieved current list (420) at the selected level. If the versions identifiers match (418) or the update (420) is completed at the current ancestor level, a determination as to if additional ancestors existing may be made (421). If additional ancestors are identified, the next highest ancestor level may be selected if applicable (422). Once each existing ancestor level has been analyzed to compare version identifiers, the query may be executed accordingly (412) using the current version of the data object In scenarios in which a query or other task reference multiple data objects, the operational flow diagram 400 may be performed for each of the referenced data objects.

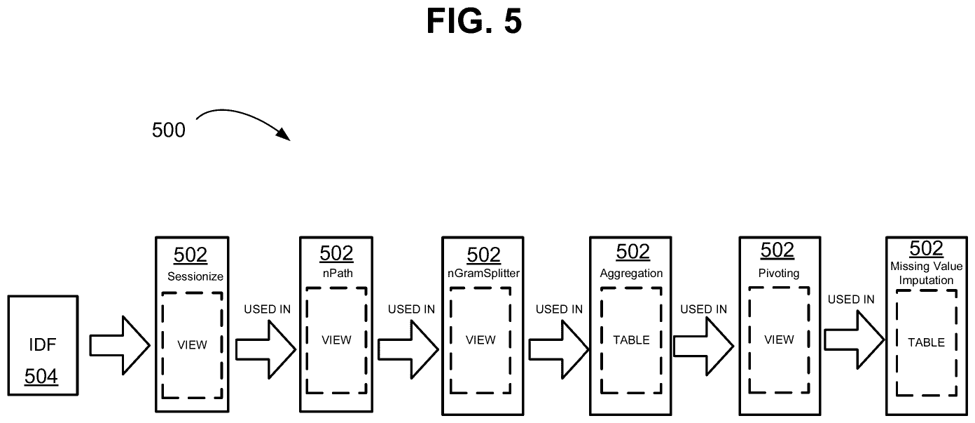

Versioning of data objects becomes increasingly important as more advanced workflows come into existence. For example, FIG. 5 shows a feature engineering workflow 500, with various applications/tools 502. Data from an integrated data foundation (“IDF”) 504, which may represent one more storage devices from which data may be retrieved, may be used by the applications/tools 502. As shown in FIG. 5, views and tables may be used over and over downstream, which may include additional views, causing ancestor levels to be created. Because this can become overly burdensome, the versioning of tables and views may allow each application/tool 502 to confirm the current versions using processes such as that described in FIG. 4.

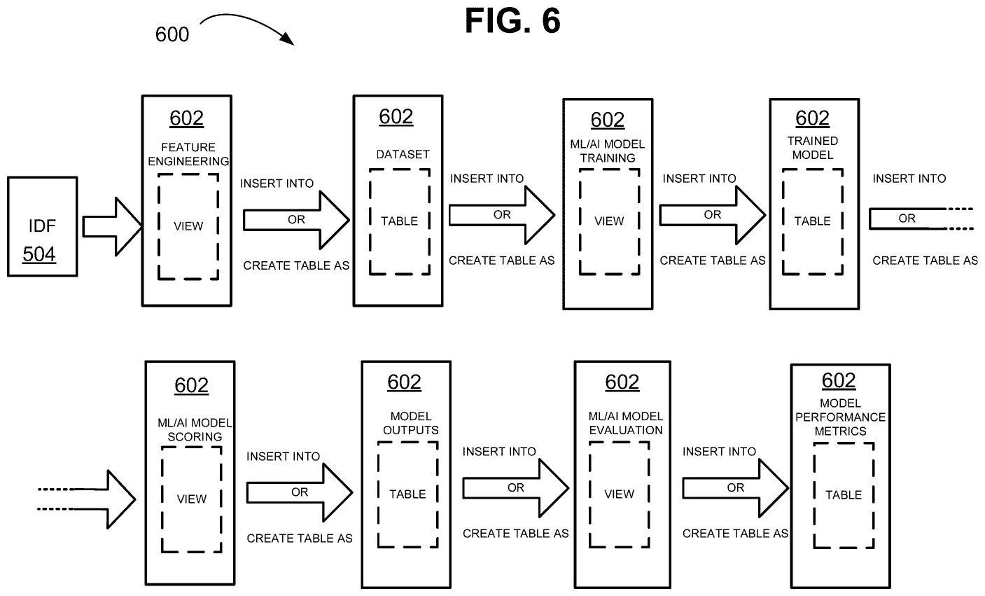

Versioning also allows current views and tables to be used in complex machine learning workflows, such as in the example of FIG. 6. In one example, the machine learning workflow 600 includes various stages 602 that use versions and tables that cascade throughout. Each of the stages 602 may use one or more tables or views in a cascading fashion using the current versions of data objects. Without the versioning, each stage runs the risk of using out-of-date views/tables resulting in less than optimal results.

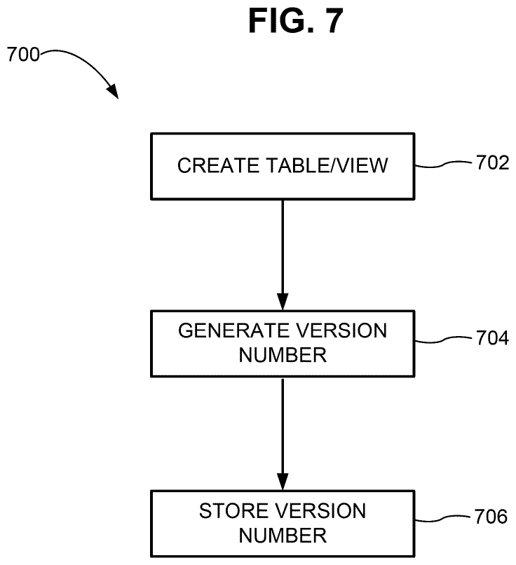

FIG. 7 is an operational flow diagram 700 of example data object versioning. In one example, a table or view may be created (702). The system responsible for creating the data object may generate an associated version identifier (704), which can be represented in various manners. The version identifier may be stored (706), such as in a centrally-located repository (see FIG. 12) or through a distribute fashion.

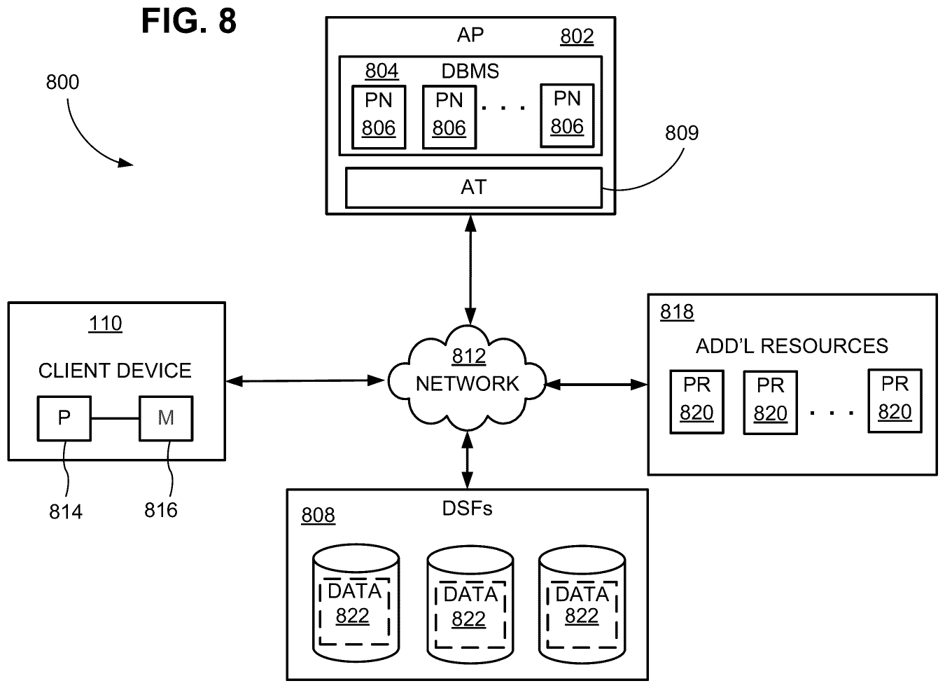

FIG. 8 is an example of the analytic environment 800 may include an analytic platform (“AP”) 802, such as Teradata Vantage. The analytic platform 802 may include one or more systems that may be used independently or with one another in carrying out advanced analytics. The analytic platform 802 may include a relational database management system (“RDBMS”) 804. In one example, the RDBMS 804 may implement a parallel-processing environment to carry out database management. The RDBMS 804 may be a combination of software (e.g., computer program routines, subroutines, applications, etc.) and hardware (e.g., processors, memory, etc.). In the example of FIG. 8, the RDBMS 804 may be a massive parallel processing (MPP) system having an identifier of processing nodes 806. In alternative examples, the RDBMS 804 may implement a single processing node, such as in a symmetric multiprocessing (SMP) system configuration. The RDBMS 804 may include one or more processing nodes 806 used to manage the storage, retrieval, and manipulation of data in data storage facilities (DSFs) 808. The processing nodes 806 may manage the storage, retrieval, and manipulation of data included in a database. The RDBMS 804 may carry out the versioning of created data objects, such as tables and views as described herein.

The analytic environment 800 may include a client device 810 that communicates with the analytic platform 802 via a network 812. The client device 810 may represent one or more devices, such as a graphical user interface (“GUI”), that allows user input to be received. The client device 810 may include one or more processors 814 and memory(ies) 816. The network 812 may be wired, wireless, or some combination thereof. The network 812 may be a cloud-based environment, virtual private network, web-based, directly-connected, or some other suitable network configuration. In one example, the client device 810 may run a dynamic workload manager (DWM) client (not shown).

The analytic environment 100 may also include additional resources 818. Additional resources 818 may include processing resources (“PR”) 820. In a cloud-based network environment, the additional resources 818 may represent additional processing resources that allow the analytic platform 802 to expand and contract processing capabilities as needed.

In one example, a client device 810 may be used to submit tasks, such as database queries, to the analytic platform 802, which may be processed by the RDBMS 804. The client device may include one or more processors 814 and/or memory(ies) 816. During operation, the analytic platform 802 may implement the additional resources 818 in order to optimize execution of the various tasks received.

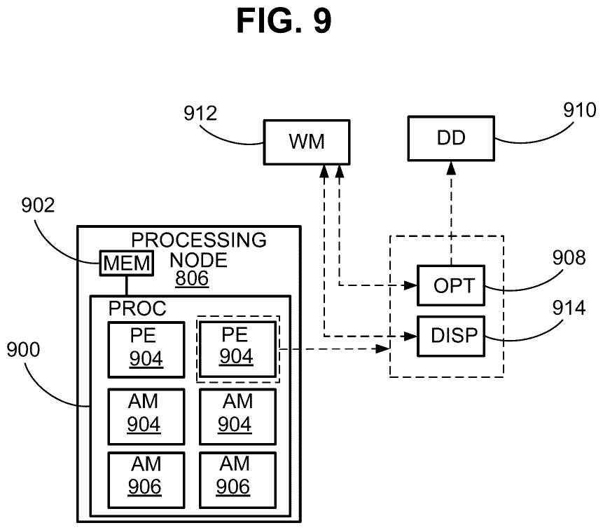

FIG. 9 is an example of a processing node 806, which may include one or more physical processors 900 and memory(ies) 902. The memory 902 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 900 such as multiprocessing, multitasking, parallel processing and the like, for example.

The processing nodes 806 may include one or more other processing unit types such as parsing engine (PE) modules 904 and access modules (AM) 906. As described herein, each module, such as the parsing engine modules 904 and access modules 906, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 902, for example, that comprises instructions executable with the processor 900 or other processor to implement one or more of the features of the module. When any one of the modules includes the portion of the memory that comprises instructions executable with the processor, the module may or may not include the processor. In some examples, each module may just be the portion of the memory 902 or other physical memory that comprises instructions executable with the processor 900 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 906 may be access modules processors (AMPs), such as those implemented in the Teradata Active Data Warehousing System®.

The parsing engine modules 904 and the access modules 906 may each be virtual processors (vprocs) and/or physical processors. In the case of virtual processors, the parsing engine modules 904 and access modules 906 may be executed by one or more physical processors, such as those that may be included in the processing nodes 806. For example, in FIG. 8, each parsing engine module 904 and access module 906 is associated with a respective processing node 806 and may each be executed as one or more virtual processors by physical processors 900 included in the respective processing node 806.

In FIG. 9, each processing node 806 is shown as including multiple parsing engine modules 904 and access modules 906, such that there are more parsing engine modules 904 and access modules 906 than processing nodes 806. In one example, during operation, the one or more physical processors 900 included in the processing nodes 806 may execute the parsing engine modules 904 and access modules 906 by switching between the executions of the various modules at a rapid rate allowing the vprocs to substantially operate in “parallel.”

The analytic platform 902 stores data 822 in one or more tables in the DSFs 808. In one example, the data 822 may represent rows of stored tables are distributed across the DSFs 808 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 808 and associated access modules 906 by a hash bucket map. The characteristics of the columns chosen for the primary index determine how evenly the rows are distributed.

Rows of each stored table may be stored across multiple DSFs 808. Each parsing engine module 904 may organize the storage of data and the distribution of table rows. The parsing engine modules 904 may also coordinate the retrieval of data from the DSFs 808 in response to queries received, such as those received from a client system 808 connected to the RDBMS 804 through connection with a network 812.

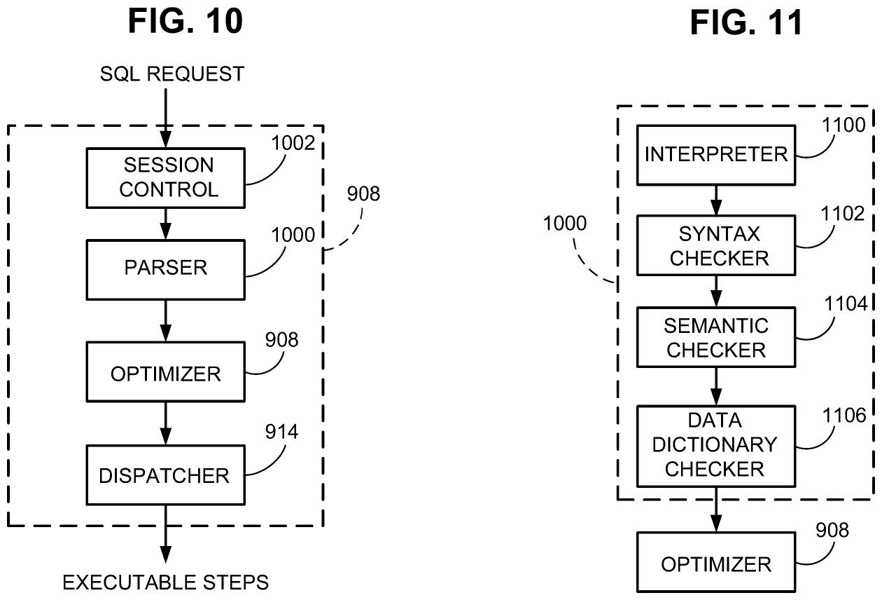

Each parsing engine module 904, upon receiving an incoming database query may apply an optimizer module 908 to assess the best plan for execution of the query. An example of an optimizer module 908 is shown in FIG. 9 with regard to a parsing engine module 904. Additional description of the parsing engine modules 904 is provided with regard to FIGS. 10 and 11. Selecting the optimal query-execution plan may include, among other things, identifying which of the processing nodes 806 are involved in executing the query and which database tables are involved in the query, as well as choosing which data-manipulation techniques will serve best in satisfying the conditions of the query. To this end, for each parsing engine module 904, a parser module 1000 (see FIG. 10), and/or optimizer module 908 may access a data dictionary module 910, shown in FIG. 9 specifically for parsing engine module 904 for purposes of illustration.

The data dictionary module 910 may specify the organization, contents, and conventions of one or more databases, such as the names and descriptions of various tables maintained by the RDBMS 804 as well as fields/columns of each database, for example. Further, the data dictionary module 910 may specify the type, length, and/or other various characteristics of the stored tables. The RDBMS 804 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language models (LLM) and artificial intelligence (AI), for example, may be implemented in the RDBMS 804 separately or in conjunction with SQL. The data dictionary 910 may be stored in the DSFs 808 or some other storage device and selectively accessed.

The RDBMS 804 may include a workload management system workload management (WM) module 912. The WM module 912 may be implemented as a “closed-loop” system management (CLSM) architecture capable of satisfying a set of workload-specific goals. In other words, the RDBMS 804 is a goal-oriented workload management system capable of supporting complex workloads and capable of self-adjusting to various types of workloads. The WM module 912 may communicate with each optimizer module 908, as shown in FIG. 9, and is adapted to convey a confidence threshold parameter and associated parameters to the optimizer module 908 in communication. Further, the WM module 912 may communicate with a dispatcher module 914 of each parsing engine module 906 (as shown in detail in FIG. 9 for parsing engine module 906 to receive query execution plan costs therefrom, and to facilitate query exception monitoring and automated modifications of confidence threshold parameters in accordance with disclosed embodiments.

The WM module 912 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g., adjusting and managing) the workload flow and priorities to achieve the SLGs; and 4) correlating the results of the workload and taking action to improve performance. In accordance with disclosed embodiments, the WM module 912 is adapted to facilitate control of the optimizer module 208 pursuit of robustness with regard to workloads or queries.

An interconnection (not shown) allows communication to occur within and between each processing node 806. For example, implementation of the interconnection provides media within and between each processing node 806 allowing communication among the various processing units. Such communication among the processing units may include communication between parsing engine modules 904 associated with the same or different processing nodes 806, as well as communication between the parsing engine modules 904 and the access modules 906 associated with the same or different processing nodes 806. Through the interconnection, the access modules 906 may also communicate with one another within the same associated processing node 806 or other processing nodes 806.

The interconnection may be hardware, software, or some combination thereof. In instances of at least a partial-hardware implementation the interconnection, the hardware may exist separately from any hardware (e.g., processors, memory, physical wires, etc.) included in the processing nodes 806 or may use hardware common to the processing nodes 806. In instances of at least a partial-software implementation of the interconnection, the software may be stored and executed on one or more of the memories 902 and processors 900 of the processing nodes 806 or may be stored and executed on separate memories and processors that are in communication with the processing nodes 806. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 806.

In one example system, each parsing engine module 906 includes three primary components: a session control module 1002, a parser module 1000, and the dispatcher module 914 as shown in FIG. 10. The session control module 1002 provides the logon and logoff functions. It accepts a request for authorization to access the database, verifies it, and then either allows or disallows the access. Once the session control module 1002 allows a session to begin, an SQL request may be received such as through submission by a user and the SQL request is routed to the parser module 1000.

As illustrated in FIG. 11, the parser module 1000 may include an interpreter module 1100 that interprets the SQL request. The parser module 1000 may also include a syntax checker module 1102 that checks the request for correct SQL syntax, as well as a semantic checker module 1104 that evaluates the request semantically. The parser module 1002 may additionally include a data dictionary checker 1106 to ensure that all of the objects specified in the SQL request exist and that the user has the authority to perform the request. The parsing engine module 906 implements the optimizer module 908 to select the least expensive plan to perform the request, and the dispatcher 914 coordinates the runtime execution of executable steps of the query execution plan of the optimizer module 208 with the access modules 906.

In one example, to facilitate implementations of automated adaptive query execution strategies, such as the examples described herein, the WM module 912 monitoring takes place by communicating with the dispatcher module 914 as it checks the query execution step responses from the access modules 906. The step responses include the actual cost information, which the dispatcher module 914 may then communicate to the WM module 912 which, in turn, compares the actual cost information with the estimated costs of the optimizer module 908.

FIG. 12 is a block diagram of an example of current version identifiers of data objects being compared to local version identifiers of the data objects maintained at the application/tool level. In one example, each application/tool 1200 may maintain a local version listing 1202 that contains data object names of data objects previously used and last-known versions. Current data object information 1204 such as data object names and current version identifiers (and ancestor information if it exists), may be stored in current version listing 1206 for each created data object. The current version listing 1206 may be maintained in the analytic system 802, such as in the data dictionary 910, for example. However, the listing 1206 may also be maintained in a distributed fashion. During operation, when an application/tool 1200 queries a view/table, the application/tool 1200 may use the local version listing 1202 to identify the local data object information 1208, which includes the data object name, last known version identifier, and ancestors information if it exists, while also retrieving the current data object information 1204 for the data object. A comparison 1210 may be performed between the sets of information, which may include the manners of comparison described herein. Based on the comparison, the application/tool 1200 may determine if the current version of the data object matches that in the local version listing 1202. If it is not the current version, the local version listing 1202 may be updated with the information obtained from the current version list 1206 and the query may be executed.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

1. A system comprising:
a storage device;
at least one processor in communication with the storage device, the at least one processor configured to:
receive a query that comprises a reference to at least one data object;
identify a locally-stored version of the at least one data object;
retrieve a current version of the at least one data object, wherein the current version is maintained in a remotely-stored data structure;
compare the locally-stored version and the current version of the at least one data object;
in response to the locally-stored version being different than the current version, prior to execution of the query, update the locally-stored version to the current version; and execute the query based on the current version of the at least one data object.

2. The system of claim 1, wherein each data object has a version identifier, wherein the at least one processor is configured to:
compare the locally-stored version identifier and the current version identifier of the at least one data object; and
in response to the locally-stored version identifier being different than the current version identifier, update the locally-stored version to the current version.

3. The system of claim 2, wherein an initial data object identifier is generated upon creation of the data object.

4. The system of claim 1, wherein the locally-stored version of the data object is stored in local storage of the system.

5. The system of claim 1, wherein the data object is a table or a view.

6. The system of claim 1, wherein the at least one data object is a view, and wherein the at least one processor is further configured to;
identify ancestor levels of the view;
beginning with the next-to-lowest level of the ancestor levels, compare locally-stored versions of each data object at each ancestor level to current versions of each data object at the ancestor level;
in response to each locally-stored version of each data object being different than the current version at each ancestor level, update the locally-stored version to the current version; and
execute the query based on a current version of the view.

7. The system of claim 1, wherein data object names and associated current version identifiers are maintained in a centralized repository.

8. A method comprising:
receiving, with a processor, a query that comprises a reference to at least one data object; identifying, with the processor, a locally-stored version of the at least one data object;
retrieving, with the processor, a current version of the at least one data object, wherein the current version is maintained in a remotely-stored data structure;
comparing, with the processor, the locally-stored version and the current version of the at least one data object;
in response to the locally-stored version being different than the current version, updating, with the processor, the locally-stored version to the current version; and
executing, with the processor, the query based on the current version of the at least one data object.

9. The method of claim 8, wherein each data object has a version identifier, wherein method further comprises:
comparing, with the processor, the locally-stored version identifier and the current version identifier of the at least one data object; and
in response to the locally-stored version identifier being different than the current version identifier, updating, with the processor, the locally-stored version to the current version.

10. The method of claim 9, wherein an initial data object identifier is generated upon creation of the data object.

11. The method of claim 8, wherein the locally-stored version of the data object comprises a data structure listing version ancestors.

12. The method of claim 8, wherein the data object is a table or a view.

13. The method of claim 8, wherein the at least one data object is a view, and wherein the method further comprises:
identifying, with the processor, ancestor levels of the view;
beginning with the next-to-lowest level of the ancestor levels, comparing, with the processor, locally-stored versions of each data object at each ancestor level to current versions of each data object at the ancestor level;
in response to each locally-stored version of each data object being different than the current version at each ancestor level, updating, with the processor, the locally-stored version to the current version; and
executing, with the processor, the query based on a current version of the view.

14. A non-transitory computer-readable medium encoded with a plurality of instructions executable by a processor, the plurality of instructions comprising:
instructions to receive a query that comprises a reference to at least one data object;
instructions to identify a locally-stored version of the at least one data object;
instructions to retrieve a current version of the at least one data object, wherein the current version is maintained in a remotely-stored data structure;
instructions to compare the locally-stored version and the current version of the at least one data object;
in response to the locally-stored version being different than the current version, instructions to update the locally-stored version to the current version; and
instructions to execute the query based on the current version of the at least one data object.

15. The non-transitory computer-readable medium of claim 14, wherein each data object has a version
identifier, and wherein the plurality of instructions further comprises:
instructions to compare the locally-stored version identifier and the current version identifier of the at least one data object; and
in response to the locally-stored version identifier being different than the current version identifier, instructions to update the locally-stored version to the current version.

16. The non-transitory computer-readable medium of claim 15, wherein an initial data object identifier is generated upon creation of the data object.

17. The non-transitory computer-readable medium of claim 14, wherein the locally-stored version of the data object comprises a data structure listing version ancestors

18. The non-transitory computer readable-medium of claim 14, wherein the data object is a table or a view.

19. The non-transitory computer-readable medium of claim 14, wherein the at least one data object is a view, and wherein the plurality of instructions further comprises:
identifying, with the processor, ancestor levels of the view;
beginning with the next-to-lowest level of the ancestor levels, instructions to compare locally-stored versions of each data object at each ancestor level to current versions of each data object at the ancestor level;
in response to each locally-stored version of each data object being different than the current version at each ancestor level, instructions to update the locally-stored version to the current version; and
instructions to execute the query based on a current version of the view.

20. The non-transitory computer-readable medium of claim 14, wherein data object names and associated current version identifiers are maintained in a centralized repository.
